(19) United States
(12) Patent Application Publication
(10) Pub. No.: US 2024/0311750 A1
(43) Pub. Date: Sep. 19, 2024

(54) SYSTEMS AND METHODS FOR DYNAMIC DELIVERY ROUTING

(71) Applicant: Simpler Postage, Inc., Lehi, UT (US)

(72) Inventors: Jeffery Goeters, Lehi, UT (US); Jing-ta Chow, Lehi, UT (US)

(73) Assignee: Simpler Postage, Inc., Lehi, UT (US)

(21) Appl. No.: 18/417,383

(22) Filed: Jan. 19, 2024

Related U.S. Application Data
(63) Continuation of application No. 18/122,861, filed on Mar. 17, 2023, now abandoned.

(51) Int. Cl. G06Q 10/0835; G06Q 10/083

(52) U.S. Cl. CPC G06Q 10/08355; G06Q 10/0838

(57) ABSTRACT

In variants, the method for dynamic delivery routing can include: receiving a recipient identifier, determining delivery parameters based on the recipient identifier, and using the delivery parameters.

### CROSS-REFERENCE TO RELATED APPLICATIONS

This application is a continuation in part of U.S. application Ser. No. 18/122,861 filed 17 Mar. 2023, which is incorporated in its entirety by this reference.

### TECHNICAL FIELD

This invention relates generally to the shipping services field, and more specifically to a new and useful system and methods for dynamic delivery routing in the shipping services field.

### BRIEF DESCRIPTION OF THE FIGURES

FIG. 1 is a schematic representation of a variant of the method.

FIG. 2 is a schematic representation of a variant of the system.

FIG. 3 is a schematic representation of a variant of the method.

FIG. 4 is a schematic diagram of a variant of data transfer within the system.

FIGS. 5A-5D are example rulesets for variants of variable delivery parameters.

FIG. 6 is a schematic diagram of a variant of an integration of the system with a shipping services platform.

FIG. 7 depicts a variant of data transfer within the system.

FIG. 8 depicts a variant of data transfer within the system.

FIG. 9 depicts an illustrative example of using the recipient identifier to dynamically obtain delivery parameters.

FIG. 10 is a schematic representation of a variant of the system.

### DETAILED DESCRIPTION

The following description of the embodiments of the invention is not intended to limit the invention to these embodiments, but rather to enable any person skilled in the art to make and use this invention.

### 1. Overview

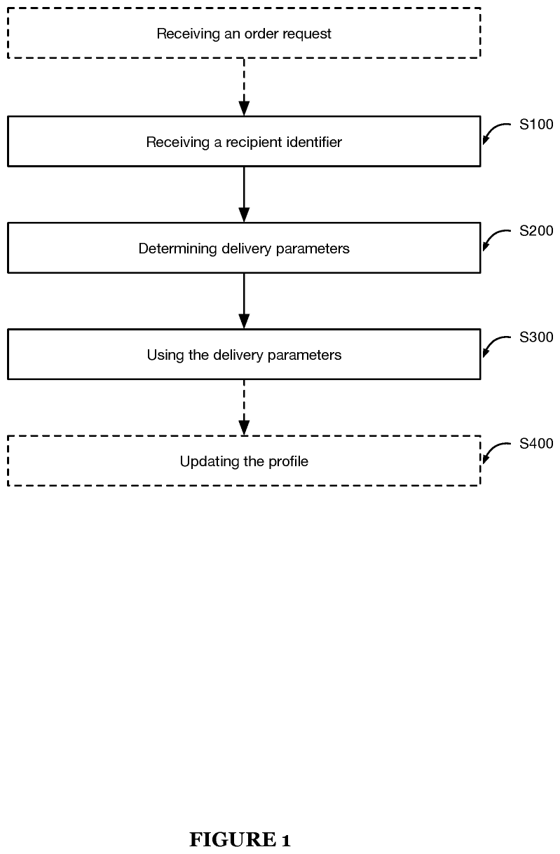

As shown in FIG. 1, the method for dynamic delivery routing can include: receiving a recipient identifier S100, determining delivery parameters based on the recipient identifier S200, and using the delivery parameters S300.

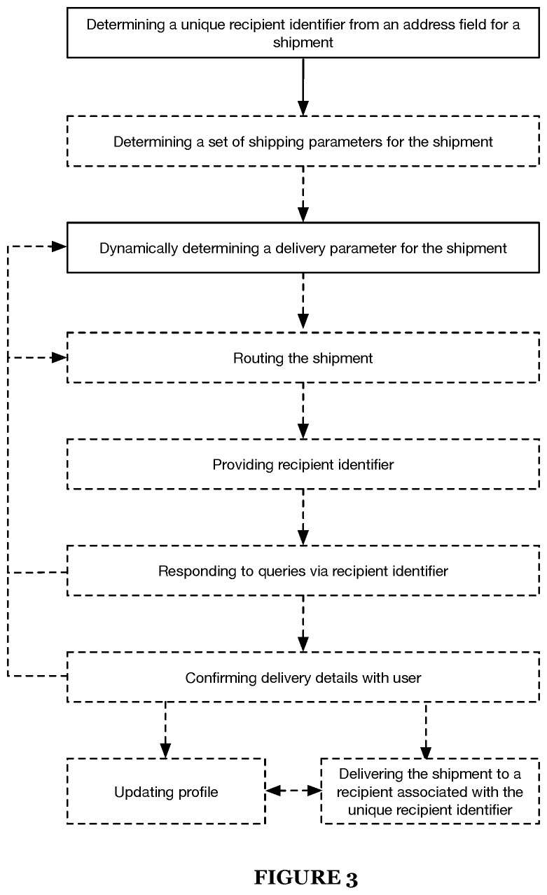

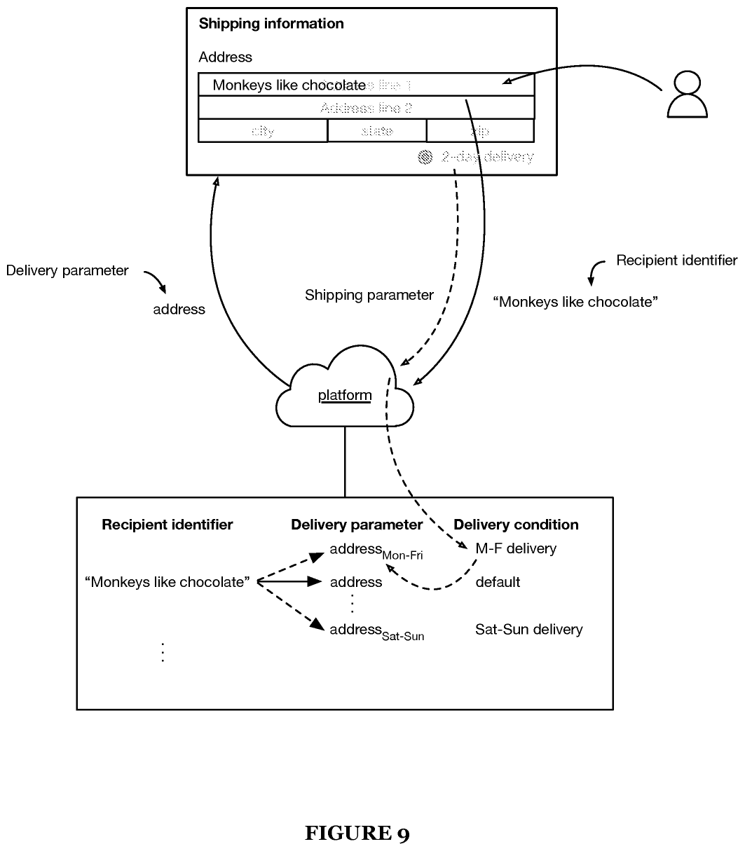

In an example, the method can include: receiving a recipient identifier associated with the destination address for a shipment (e.g., wherein the recipient identifier is received within the address field for a shipment, etc.); optionally determining shipping parameter values (e.g., estimated delivery date, estimated delivery time, ship date, carrier service, etc.); determining one or more delivery parameters based on the recipient identifier, a set of delivery rules associated with the recipient identifier and/or each delivery parameter, and optionally the shipping parameter values (e.g., to determine which of the recipient's delivery addresses or locations to use based on the estimated delivery time, which information to return to a delivery person, etc.); and facilitating delivery of the shipment based on the delivery parameters (e.g., routing the shipment) (e.g., examples shown in FIG. 3 and FIG. 9). In variants, the method can be performed by: a vendor, a fulfillment facility, a carrier sorting facility, a carrier delivery entity (e.g., delivery person, automated delivery system), and/or any other shipping entity; a platform; and/or any other suitable entity. In variants, a final delivery address can be determined while in transit, after shipping has been initiated (e.g., after an order has been placed). Alternatively, the buyer can select the delivery destination to use. In variants, the set of delivery rules can be recipient-specified, learned, looked up, and/or otherwise determined.

In an illustrative example, an online retailer can: at an e-commerce checkout, receive a recipient identifier in lieu of the destination address for an order; optionally determine a shipping date estimate (and optionally a shipping time); and provide the recipient identifier and optionally the shipping date estimate to the system, wherein the system can: determine a set of candidate delivery addresses for the recipient based on the recipient identifier (e.g., by accessing a delivery account associated with the recipient identifier); optionally estimate a delivery date and/or a price estimate associated for each of a set of potential carriers for each of a set of candidate delivery addresses for the recipient; and provide one or more of the candidate addresses, and optionally the delivery date estimates and/or carrier price estimates to the e-retailer, wherein the e-retailer or the entity placing the order (e.g., the recipient) can select a carrier service based on the candidate address, delivery date estimate, and/or carrier price estimate. The online retailer can optionally route the order to the selected carrier, and provide the recipient identifier to the selected carrier. The carrier, in turn, can deliver the shipment to the candidate address associated with the carrier price estimate, and/or deliver the shipment to another recipient address determined (e.g., by the carrier) while in transit, based on the recipient identifier.

In a second illustrative example, a delivery entity (e.g., autonomous delivery system, delivery person, etc.) can query the system for a delivery address using the recipient identifier to obtain the delivery address and/or other delivery parameters (e.g., whether to call or text the recipient, door code, gate code, etc.), wherein the delivery entity delivers the shipment based on the returned delivery parameters.

### 2. Technical Advantages

Variants of the technology for dynamic delivery routing can confer several benefits over conventional systems and methods.

First, by establishing a dynamic communication system between the customer and carrier, variants of the technology can increase the probability that an attempted shipment is completed and/or reduce the frequency of mis-delivery incidents. For example, by not providing a static printed address on the shipment, variants of the technology can require each entity in the shipping workflow to dynamically determine the delivery information (e.g., delivery address, delivery information, etc.). This enables the most up-to-date delivery parameters (e.g., address, delivery information, etc.) to be used to deliver the shipment to the recipient.

Second, variants of the technology enable shipping and fulfillment system to programmatically and/or dynamically obtain delivery parameters. In variants, this can be enabled by using a recipient identifier that represents the recipient instead of a static address, wherein the delivery parameters associated with the recipient identifier (e.g., delivery address, delivery instructions, delivery conditions, etc.) can be dynamically returned based on the shipping context.

Third, variants of the technology enable shipping and fulfilment services to dynamically adapt to delivery parameter changes. In variants, delivery parameter changes can be determined and/or received in real-time or in near real-time. In variants, changes to delivery parameters can be accessed even as a shipment is en route, enabling delivery services to dynamically and/or automatically reroute the shipment and/or the carrier vehicle (e.g., to avoid an expensive mis-delivery). In examples, this can enable recipients to redirect a shipment in real- or near-real time to a new address when they are going on vacation, when they have left the original delivery address, and/or in other situations.

Fourth, variants of the technology can confer improvements to the computing systems themselves. First, variants of the technology can reduce the amount of memory required to store the recipient information by storing the recipient delivery parameters in a centralized system that is queried by disparate entities (e.g., carriers, etc.), which can reduce or eliminate the need for each entity to independently, redundantly store the recipient information. The routing capability across this network is vastly enhanced while the memory required to improve routing capability is reduced, as all user data can be stored in one centralized account, retrieved by various entities (e.g., via API call), and used and erased by individual entities as needed. In an example, by reducing or eliminating the need for merchants or carriers to directly access personally identifiable information and/or high-security information (such as credit card information), and/or by limiting PII access based on the requesting account's access permissions, variants of the technology can improve privacy for the individual and decrease liability for merchants and carriers. In further examples, the recipient identifier imbeds all a shopper's delivery preferences (e.g., addresses, instructions, time windows, contact information, etc.) into one address field. Second, variants of the technology can reduce the computational power needed to validate the addresses by verifying the delivery parameters (e.g., delivery address, delivery information, etc.) at the platform. This can reduce or eliminate the need for each shipping entity (e.g., vendor, fulfillment center, carrier, etc.) to independently and redundantly re-verify the address. Alternatively, each entity can also verify the delivery parameters (e.g., delivery address, delivery information, etc.) received from the platform.

Fifth, due to the high variability of shipping logistics, transit prediction models have low confidence levels and require computationally intensive model training and/or model architecture to account for significant shipping irregularities. Variants of the technology can perform a dynamic, real-time optimization of shipment routing using multiple machine learning models. In variants, this can provide an optimized shipment route despite low accuracy of individual transit predictions at the time of shipment. Additionally, this can reduce the computational resources needed to determine an optimal shipping route given a set of user delivery preferences by reducing model complexity and/or reducing the amount of training data needed. In an example, updated information can be received after shipping a package (e.g., updated scan data indicating the package has arrived a day earlier than predicted to a distribution center, updated weather information indicating a severe storm, updated delivery preferences, etc.). In response to this updated information, a set of machine learning models can output updated transit predictions for a set of candidate shipping routes (e.g., for different shipping carriers, for different delivery locations, etc.), and the package can be automatically rerouted to a new (optimized) route selected based on the updated transit predictions.

However, the technology can confer any other suitable benefits.

### 3. System

The method can be performed by a system 100, which can function to facilitate the delivery of a shipment to a recipient. The shipment can be: an order, an item, a package, a piece of mail, a mail piece, a set of physical objects, and/or be otherwise defined.

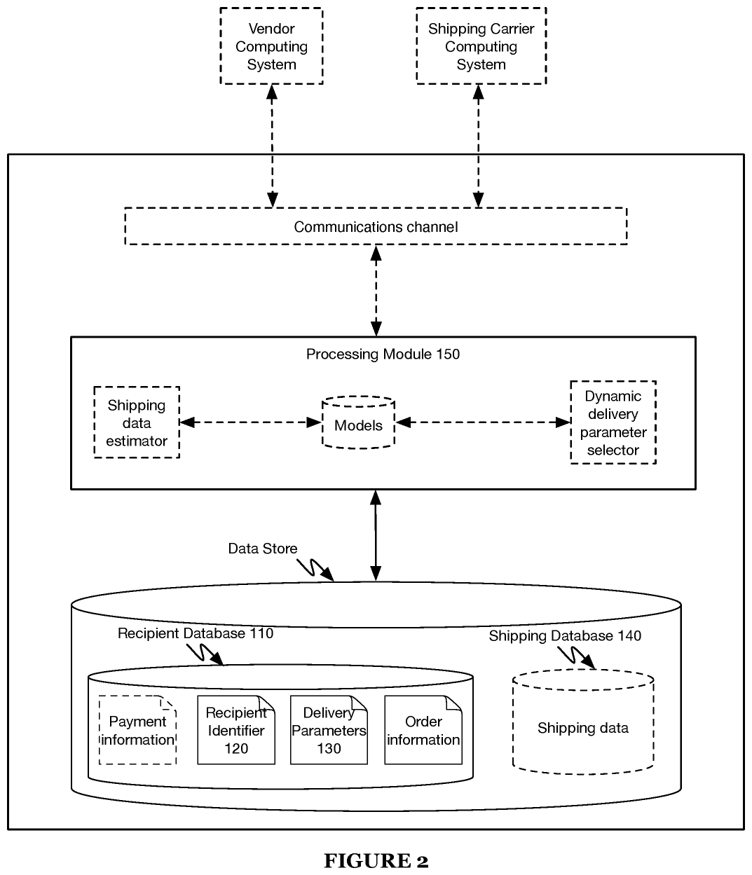

As shown in FIG. 2, the system can include: one or more data stores including a recipient database 110 and a shipping database 140, and a processing module 150. However, the system can additionally or alternatively include any other elements.

The system can be used with: shipping recipients (e.g., individual shoppers, businesses, etc.), shippers or vendors (e.g., online retailers, physical retailers, omnichannel retailers, etc.), fulfilment centers, shipping providers, and/or any other suitable shipping entity. Shipping providers can include shipping companies (e.g., carriers such as UPS, USPS, FedEx, airlines, trucking companies, etc.), local pickup and delivery services (e.g., TaskRabbit, Uber, Lyft, etc.), couriers (e.g., postman, driver, etc.), and/or any other entity involved in the transport of goods.

The system can include one or more communication channels which can function to enable data transfer between entities, sub-systems, and/or components of the system. In the latter variants, communication channels can include: APIs (e.g., using API requests and responses, API keys, etc.), requests, interfaces (e.g., a website, an application, etc.), a messaging system (e.g., SMS, email, etc.) and/or other any other means of digital communication. In examples, the communication channel can allow the processing system to communicate with one or more: customers (e.g., the recipient attached to the recipient profile, via the customer computing system, etc.), vendors (e.g., via the vendor computing system), shippers (e.g., via the shipping carrier computing system), and/or any other entities. However, the communication channel(s) can be otherwise configured.

The recipient database 110 preferably functions to store recipient profiles for a set of recipients. The recipient can be an individual, a set of individuals (e.g., a family), a business, an organization, another legal entity, a delivery service (e.g., carrier, courier, etc.), and/or any other designated recipient. The recipient database 110 is preferably located in the remote servers of a shipping services platform (e.g., EasyPost), but may alternatively be located in a cloud data structure, in local servers, in a distributed storage system, and/or in any other computing system. Access to information stored within the recipient database can be controlled by sets of permissions, such as login credentials, API tokens, and/or other permissions; alternatively, the information can be freely accessible. The recipient database can store recipient profiles and/or other information associated with each recipient. In an example, each recipient profile can be stored in a central, cloud-based, repository including the delivery preferences of a particular consumer, which can be accessed and updated by said customer and accessed by other entities. In another example, personally identifiable information about each recipient and/or high-security information (e.g., credit card information) can be masked and only accessible to those with access.

Each recipient profile can include and/or be associated with: a recipient identifier 120, a set of delivery parameters 130, order information, contact information, payment information, login information (e.g., recipient username and password, etc.), and/or any other information associated with the recipient.

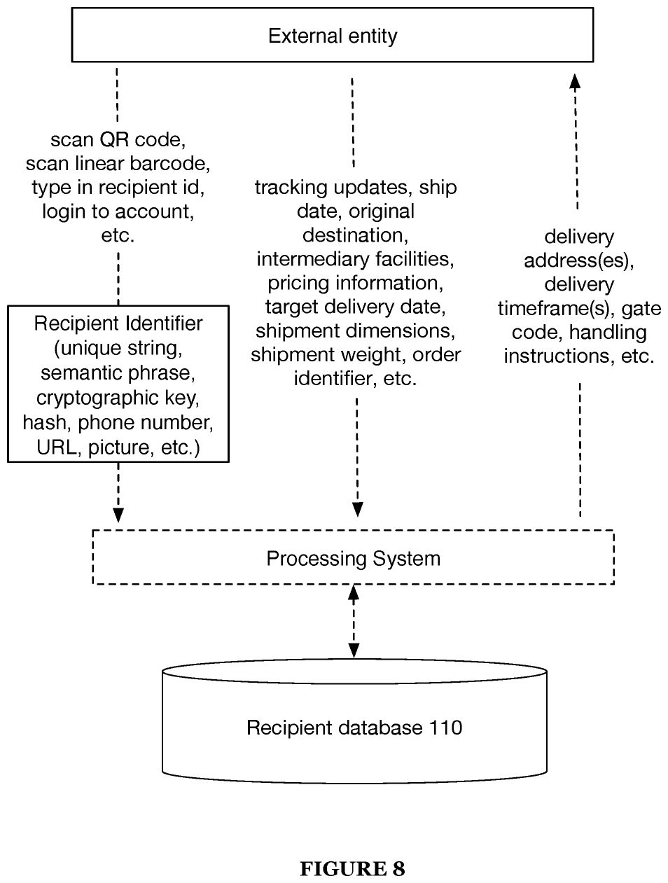

The recipient identifier 120 provides an identifier that can be mapped to one or more sets of delivery parameters 130. Each unique recipient (e.g., user, receiving entity, etc.) is preferably associated with a single identifier, but can alternatively be associated with multiple identifiers. The recipient identifier can be determined: manually, automatically, randomly, calculated, and/or otherwise determined. The recipient identifier can be a: picture, barcode (e.g., QR code, linear barcode, etc.), combination of semantic words (e.g., a combination of 3 words, 4 words, etc.), a semantic phrase (e.g., wherein the phrase itself has meaning), including an alphanumeric string, cryptographic key, hash (e.g., blockchain address, hash of the recipient's name, hash of an image of the recipient, hash of the recipient's fingerprint or other biometric, etc.), phone number, email address, token, address (e.g., address within the set of addresses associated with the recipient or recipient identifier, etc.), URL, IP address, MAC address, IMEI number, web browser cookie, and/or any other unique identification representation (e.g., examples shown in FIG. 8). The recipient identifier can be a virtual identifier and/or a physical identifier. Optionally, the recipient identifier can be printed onto a physical label and attached to a shipment (printed in an address field on a mailing label for a shipment). The recipient identifier is preferably globally unique, but can alternatively be nonunique (e.g., wherein other information can be used to disambiguate the recipients). Preferably, the recipient identifier is quickly and easily accessed. In examples, the recipient identifier is accessed by scanning, typing in, clicking on, photographing, and/or otherwise interacting with the recipient identifier. Alternatively, the recipient identifier can be: protected (e.g., password protected), multi-faceted (e.g., wherein the recipient identifier includes two or more unique identifiers), and/or otherwise configured.

The recipient identifier 120 can be issued to the recipient: when the recipient signs up for a dynamic delivery service, automatically (e.g., by a vendor), upon receipt of a recipient identifier request, and/or at any other suitable time. Alternatively, the recipient identifier can be not explicitly sent to the recipient, wherein the system can automatically determine a recurring piece of recipient information and uses the recurring piece of recipient information as the recipient identifier. For example, the system can aggregate the recipient delivery locations (e.g., from repeated deliveries to the recipient, from repeated queries to the recipient, from dynamically determined recipient locations, from third party services, from postal services, etc.), wherein any delivery location within the set of recipient delivery locations can function as the recipient identifier. However, the recipient identifier can be otherwise provided to the recipient.

In use, the recipient identifier can be entered into the shipping address field, used in lieu of a shipping address, or otherwise used (e.g., example shown in FIG. 9).

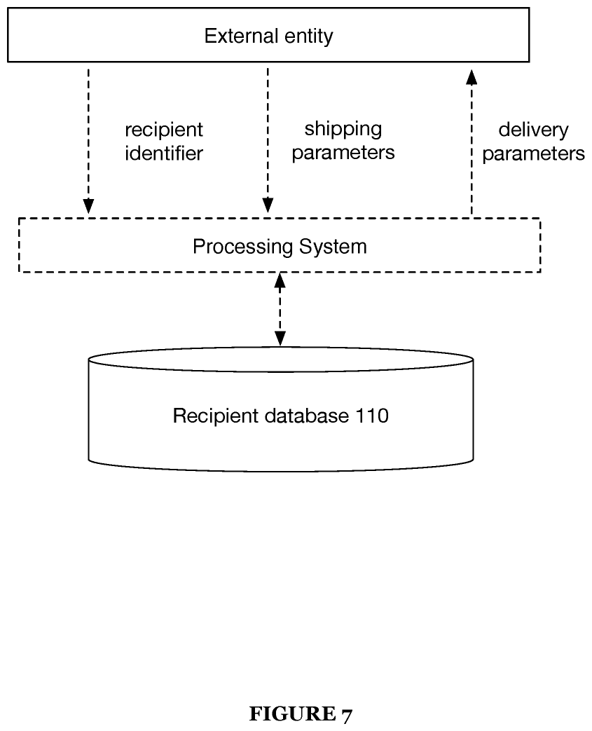

The set of delivery parameters 130 can store all information relevant to a recipient's delivery preferences (e.g., dynamic delivery preferences) in association with one recipient profile and/or recipient identifier 120. One or more sets of delivery parameters 130 can be associated with the recipient identifier 120. One or more delivery parameters from the set of delivery parameters can be returned based on the recipient identifier, such as in response to a request including the recipient identifier (e.g., example shown in FIG. 7). However, the delivery parameters can be otherwise used.

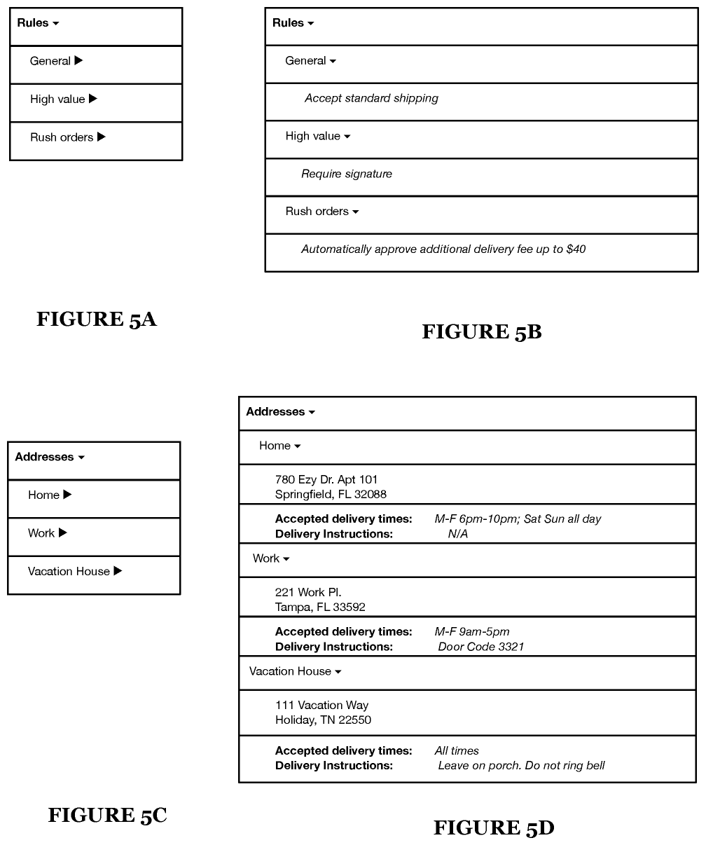

The set of delivery parameters 130 preferably specifies where, when, and/or how to deliver a shipment to the recipient (e.g., examples shown in FIGS. 5A-5D), but can additionally or alternatively specify where and/or when a recipient will be located (e.g., for ridesharing or autonomous vehicle pickup), and/or any other suitable spatiotemporal recipient information. Preferably, the set of delivery parameters are variable (e.g., dynamic delivery parameters), wherein the parameters specify multiple possible outcomes for delivery and/or are determined after the shipment has been sent (e.g., while the shipment is en route, before the shipment is delivered, etc.). Alternatively, the parameters can be static (e.g., a single address for a single recipient).

The delivery parameters 130 can include one or more: delivery locations (e.g., work address, home address, vacation address, etc.), delivery instructions, delivery conditions, and/or other information. Delivery parameters 130 can also be associated with and/or include a label (e.g., “office”, “home”, etc.), delivery conditions (e.g., when the delivery parameters should be used), a set of permissions (e.g., when the delivery parameters can be accessed, who can access the delivery parameters, how long the delivery parameters are accessible for, etc.), and/or other parameters. The delivery parameters can be validated by the platform (e.g., each delivery address is verified as a valid address by the platform); additionally or alternatively, the delivery parameters can be unvalidated and/or be validated by the endpoint consuming the delivery parameter (e.g., the vendor, the fulfillment facility, the carrier, etc.).

The delivery location can be: a delivery address, a building identifier (e.g., building name, such as “Sears Tower”), a geolocation, a geocode, a pickup and/or drop-off site (e.g., a delivery locker, P.O. box, parcel locker, store, etc.), and/or any other suitable delivery location. The delivery location can be: received from the recipient (e.g., manually entered, etc.), dynamically determined, inferred, and/or otherwise determined. The delivery location can be stored in a conventional format (e.g., address; street address, city, state, zip; etc.), in a carrier-specific format (e.g., using carrier-specific abbreviations), as a set of geocoordinates (e.g., latitude, longitude, altitude, etc.), and/or otherwise represented. In a first example, the delivery addresses are received from the recipient (e.g., during recipient profile setup, as part of a response to a shipping confirmation, etc.). In a second example, the delivery addresses are determined from shipments to the recipient. In a third example, the delivery location can be determined from or be the recipient's location, wherein the recipient's location can be determined from: the recipient's device (e.g., smartphone, application executing on their smartphone, etc.), external systems monitoring the recipient location (e.g., facial recognition system, etc.), and/or otherwise determined. In a fourth example, the delivery locations can be aggregated from third party databases, such as postal service databases, yellow pages, professional databases, tax assessor databases, and/or other databases. However, the delivery addresses can be otherwise determined.

The delivery instructions can include: a gate code, recipient contact information (e.g., phone number, email address, social media handle, etc.), recipient contact instructions or preferences (e.g., do not call hours; contact the recipient for shipments over a threshold value; preferred contact channel, such as SMS vs. phone call; etc.), handling instructions (e.g., handle with care; specifics on where to leave a shipment including: front porch, back door, with doorman, required signature, etc.), accepted delivery times, and/or any other instructions. The delivery instructions can be uniquely associated with a specific delivery location, or be common across all or a subset of the delivery locations of the recipient. The delivery instructions can be: received from the recipient (e.g., when the recipient is setting up the delivery parameter set; in response to a message sent to the recipient before shipment delivery, such as from responses to SMS inquiries to confirm the delivery instructions; etc.), received on behalf of the recipient (e.g., by an entity shipping a shipment to the recipient), received from a vendor (e.g., in association with a delivery location), inferred based on a delivery location class (e.g., defaults to “leave with doorman” when in New York or in a high rise), and/or otherwise determined.

The delivery conditions can be used to determine which delivery parameter 130 to use (e.g., to route a shipment) and/or return (e.g., in response to an API request). The delivery conditions can be: a rule set (e.g., set of conditionals), a decision tree, a set of heuristics, a neural network (e.g., predict which delivery parameters and/or class of delivery parameters to use based on shipping parameters), and/or any other mechanism for determining which delivery parameter to use. Preferably, the delivery conditions are tailored to the specific recipient, but can alternatively be common and/or shared across multiple recipients. The delivery conditions can be: received from the recipient (e.g., manually entered), learned (e.g., inferred over time from: whether or not the recipient was present, the recipient's location at different times, the recipient's calendar, the delivery parameters provided by the recipient on a delivery-by-delivery basis, etc.), and/or otherwise determined. The delivery conditions can be based on: timeframes (e.g., when to deliver), value (e.g., how to deliver a shipment based on its value), costs (e.g., a maximum delivery fee to automatically accept), and/or any other conditions.

The delivery conditions can include timeframes which can specify when to and/or when not to deliver. In a first example, timeframes can specify when to/when not to deliver to each of a set of addresses associated with the recipient (e.g., deliver to address A Monday-Thursday between 9-5 pm or deliver to address B at all other times, etc.). In a second example, timeframes can specify when not to deliver (e.g., no deliveries on Sundays, no deliveries after 9 pm, no deliveries during a designated vacation period, etc.). In a third example, the delivery conditions can specify which delivery parameter class or label to use for each timeframe (e.g., deliver to “work” M-F between 9-5 pm and deliver to “home” otherwise). The delivery conditions can also include preferences (e.g., weighted preferences, ranked preferences, address of last resort, etc.) associated with one or more of the delivery addresses, delivery timeframes, delivery instructions, and/or other parameters.

However, the set of delivery parameters 130 can be associated with any other suitable information.

Preferably, the recipient can update the set of delivery parameters 130 associated with their recipient profile (e.g., via a website, via an application, by text, by email, etc.). In a first variant, the recipient can update their delivery parameters and future orders will incorporate the updated parameters. In a second variant, the recipient can update their delivery parameters for one or more current (e.g., in-progress) orders. In an example, the recipient can initiate a last-minute intercept, wherein the recipient updates the delivery parameters (e.g., the address, the delivery instructions, the acceptable delivery time window, etc.) for an in-route order, wherein the update is pushed to a courier in possession of the shipment.

Optionally, the recipient profile can include order information, which functions to store a record of one or more current and/or past orders purchased in association with the recipient. The order information can include shipments from one or more vendors and delivered by one or more carriers. The order information can be provided by the buyer, the shipping carrier, the vendor, and/or any other suitable entity. Order information can include: tracking numbers, order numbers, receipts, order confirmations, tracking information (e.g., estimated delivery date/time, delays, tracking updates, etc.), vendors, items ordered, vendor customer service contact information, and/or any other information related to the order.

However, the recipient profile can include any other suitable information.

However, the recipient database can include any other suitable information.

The shipping database 140 preferably functions to store shipping data. Shipping data can include route information, statistical information, carrier information, predicted and/or actual delivery times, predicted and/or actual shipping costs, weather information, historical event information (e.g., events affecting shipping times such as pandemics, protests, etc.), package scan data (e.g., package location information and/or associated time information), other package information, delivery parameters (e.g., addresses, delivery conditions, other delivery preferences, etc.), and/or any other information. Route information preferably includes the probable route taken by delivery drivers to deliver items to particular areas or addresses, the times of day that deliveries occur, how long delivery from a shipping center or location to a particular area or address takes, typical traffic patterns, real-time traffic patterns, and/or any other information linked to shipping routes. Statistical information preferably includes demographics of an area, theft statistics of an area, or other statistical factors that may affect shipping. Carrier information can include a list of available carriers; published data per carrier (e.g., carrier rates, services provided, available routes, coverage regions, delivery speed, constraints, delivery day of week, quotes, etc.); historical shipping data obtained per carrier (e.g., delivery delays, estimated vs. actual delivery times, etc.); and/or any other carrier-specific information. Shipping data can be: retrieved (e.g., from a website, from a publication, etc.), requested, predicted (e.g., using one or more trained models, etc.), and/or otherwise determined. The shipping database 140 is preferably located in remote servers that are part of a shipping services platform (e.g., EasyPost), but may alternatively be located in the cloud, in local servers, and/or in other computing systems. The shipping database may be populated with data collected by the system, or from an external shipper. The shipping database preferably stores shipping data from each shipment processed through the system 100, but may alternatively only store shipping data from particular shipments. In examples, the shipping database can be or include elements of the shipping databases disclosed in: U.S. patent application Ser. No. 17/729,430 filed 26 Apr. 2022, U.S. patent application Ser. No. 17/835,286, filed 8 Jun. 2022, U.S. patent application Ser. No. 17/729,295, filed 26 Apr. 2022, or U.S. patent application Ser. No. 17/966,093, filed 14 Oct. 2022, each of which is incorporated in its entirety by this reference.

However, the shipping database can include any other information, and/or be otherwise configured.

The optional processing module 150 can function to determine which delivery parameters to return in response to receipt of a request associated with the recipient identifier. The processing module 150 can additionally or alternatively function to determine predictions (e.g., shipping data predictions, etc.) associated with a delivery parameter and/or perform other functionalities. In variants, the processing module can include a shipping data estimator (e.g., which implements the method described in S300, the system disclosed in U.S. patent application Ser. No. 17/729,295 and filed 26 Apr. 2022, the system disclosed in U.S. patent application Ser. No. 17/966,093 and filed 14 Oct. 2022, etc.), a dynamic delivery parameter selector (e.g., which implements the method described in S200), and/or any other subcomponent. In examples, the processing module 150 can determine: a delivery date or time in transit for each of the recipient's delivery addresses, a cost to deliver to each of the recipient's delivery addresses, the legs and/or intermediary facilities for the delivery routes for each of the recipient's delivery addresses, and/or other suitable information.

In a first example, the processing module can return a set of delivery parameters associated with the recipient identifier, based on the set of delivery conditions associated with the set of delivery parameters.

In a second example, the processing module can return a set of delivery parameters associated with the recipient identifier, based on a set of shipping parameters and the set of delivery conditions associated with the delivery parameter set. In this example, the set of shipping parameters can be provided by querying entity (e.g., in the request or query), looked up, inferred or predicted (e.g., using a trained neural network, etc.), retrieved, determined based on shipping data, determined using a model, manually determined, randomly determined, and/or otherwise determined. The shipping parameters can include: ship date, origin destination, intermediary facilities, target delivery date, estimated delivery date, estimated time in transit, selected time in transit, shipment dimensions, shipment weight, order identifier, carrier information, service information, and/or any other shipping parameters. In an illustrative example, the delivery parameter(s) associated with conditions satisfied by the set of shipping parameters can be returned, used to deliver the shipment, and/or otherwise used.

In a third example, the processing module can determine shipping data, such as a shipping cost estimate, an estimated delivery timeframe (e.g., a shipping time estimate, day of week, time of day, etc.), and/or other data associated with a delivery. The shipping data can be determined based on a set of shipping parameters (e.g., inferred or received with the request), based on the delivery parameters (e.g., for each of the set of delivery parameters; a delivery timeframe is predicted for each candidate address; shipping data can include delivery parameters; etc.), and/or determined based on any other suitable data. The shipping data can be looked up, predicted using a trained machine learning model (e.g., neural network model, classifier, etc.), inferred, and/or otherwise determined. The processing module can select one or more delivery parameters (e.g., an address, an address and associated instructions, etc.) based on the respective predicted shipping data (e.g., based on user preference, based on a rule associated with delivery parameter, etc.), and/or otherwise use the shipping data. In an example, the processing module can select a delivery parameter when the respective predicted delivery time satisfies the set of conditions associated with the respective delivery parameter. In a second example, the processing module can predict the estimated time in transit for each of the set of delivery addresses (e.g., the delivery parameters) based on the ship date and origin (e.g., the shipping parameters), and select one or more delivery addresses based on the respective estimated time in transit. The processing module can return the delivery parameters associated with the delivery timeframe by the delivery condition set (e.g., upon receipt of a request, wherein the delivery parameter is looked up, etc.), automatically fill in the delivery parameter into the address field, return the delivery parameters and respective estimated shipping data (e.g., to the requesting entity, to the user, etc.), and/or otherwise use the estimated shipping data.

In a fourth example, the processing module can return the delivery parameters associated with a recipient preference. In an illustrative example, when the recipient preference includes the cheapest delivery cost, the processing module can: predict the estimated delivery cost for each of a plurality of carrier-service-delivery address combinations, and return the delivery address (and optionally the carrier and service) associated with the cheapest delivery cost, and also optionally return delivery cost, estimated delivery timeframe, and/or other shipping information.

However, the processing module can perform other functionalities. The system can include or use one or more models (e.g., a set of machine learning models). The models can include classical or traditional approaches, machine learning approaches, and/or be otherwise configured. The models can include regression (e.g., linear regression, non-linear regression, logistic regression, etc.), decision tree, clustering, association rules, dimensionality reduction (e.g., PCA, t-SNE, LDA, etc.), language processing techniques (e.g., LSA), neural networks (e.g., GNN, CNN, DNN, CAN, LSTM, RNN, FNN, encoders, decoders, deep learning models, transformers, etc.), ensemble methods, optimization methods (e.g., Bayesian optimization, multi-parameter optimization, etc.), classification, rules, heuristics, equations (e.g., weighted equations, etc.), selection (e.g., from a library), lookups, regularization methods (e.g., ridge regression), Bayesian methods (e.g., Naive Bayes, Markov, etc.), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, foundation models (e.g., language models), and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels), negative training sets (e.g., a set of data with true negative labels), and/or any other suitable set of data. In a specific example, models can be trained using historical shipping data (e.g., as a training target).

Any model can optionally be run or updated (e.g., retrained): once; at a predetermined frequency; every time all or a portion of the method is performed; every time updated data is received (e.g., shipping data, delivery parameters, delivery conditions, etc.); or at any other suitable frequency. Any model can optionally be run or updated concurrently (e.g., in parallel) with one or more other models, serially, at varying frequencies, or at any other suitable time.

However, the system can be otherwise configured, and the method can be performed with any other suitable system.

### 4. Method

The method can function to enable entities involved with the order and delivery of a shipment to access information pertinent to the delivery. In variants, the method can provide a centralized and consistent means of accessing information. All or portions of the method can be performed by: shipping recipients, vendors, fulfilment centers, shipping providers (e.g., FedEx), a shipping services platform (e.g., EasyPost), and/or any other entity.

As shown in FIG. 1, the method can include: receiving a recipient identifier S100, determining delivery parameters based on the recipient identifier S200, using the delivery parameters S300, and/or any other suitable element.

However, the method can be otherwise performed.

### 4.1 Receiving a Recipient Identifier S100

Receiving a recipient identifier S100 functions to identify the recipient and the associated delivery parameter set, which is then used to determine the delivery parameters to use (e.g., for shipment shipping and/or delivery). The recipient identifier can be received by: a platform (e.g., a shipping services platform, the system controlling the recipient profile, etc.), a third-party entity (e.g., who uses the recipient identifier to retrieve one or more delivery parameters from the platform), and/or any other suitable entity. The recipient identifier can be received from: a buyer (e.g., the recipient, a gift giver ordering on behalf of the recipient, etc.), a platform, a third-party entity involved in shipping, a third-party entity not involved in shipping (e.g., a credit card company involved in virtual check-out, a search engine, another account the buyer is logged into, etc.), and/or any other suitable entity. The recipient identifier can be received digitally and/or physically (e.g., printed onto a label attached to a package).

The method can optionally include prompting a shopper to provide their recipient identifier and/or permission to access the recipient identifier. In an example, an online vendor can display an option on their shopping site (e.g., website, mobile application, etc.) to shop with dynamic delivery functionality, wherein the user can select this option, optionally be informed that they have automatically joined a shopping session with this option enabled, enter their recipient identifier to enable this option, and/or otherwise enable dynamic delivery. Once dynamic delivery is enabled, the recipient identifier and associated delivery parameters can be accessed by the vendor.

The recipient identifier can be received in association with a delivery address and/or delivery address field (e.g., example shown in FIG. 9), received in association with a recipient location field (e.g., map location, meeting location, pickup location), and/or in association with any other suitable data field.

In a first variant, the recipient identifier is received in the delivery address field for a shipment (e.g., instead of a delivery address, in addition to the delivery address, etc.). In a first example, the recipient identifier can be printed, typed, entered into, or otherwise occupy the delivery address field. In a second example, the recipient identifier can be digitally received at or prior to a digital checkout, wherein a buyer enters the recipient identifier (e.g., in the address field) at the digital checkout. In this variant, when the delivery address field is not controlled by the platform, the receiving entity can automatically identify that the recipient identifier is associated with the platform (e.g., any three-word identifier is an EasyPost™ identifier), and automatically query the platform, and/or otherwise use the recipient identifier.

In a second variant, the recipient identifier is inferred from information received within delivery the address field(s). The information can be standard shipping information (e.g., a verifiable address, a name, an email address, etc.), and/or nonstandard shipping information. In an example, an order is received with one or more parameters including: the intended delivery address, recipient name, recipient phone number, recipient email address, and/or any other identifying parameter. One or a combination of the received parameters can be used to associate the order with the recipient profile containing the delivery parameter set.

In a third variant, the recipient identifier is received using delegated access through a web authorization standard (e.g., OAuth). In an example, a buyer can be provided the option (e.g., by clicking a button) to check out at a virtual check-out counter using a profile associated with a shipping services platform (e.g., EasyPost), wherein the platform login can function as the recipient identifier. The platform can return all of or a subset of the delivery parameters associated with the recipient identifier, provide access to further information stored in the account (e.g., credit card information), and/or provide any other suitable functionality.

In a fourth variant, the recipient identifier can be digitally received at or prior to checkout from cookies in a web browser. The cookies can be associated with a profile the buyer is signed into on an overall web browser (e.g., Chrome). The cookies can be associated with a profile the buyer is signed into on a website (e.g., Amazon, another e-commerce website, etc.). The cookies can be associated with a profile the buyer has previously signed into whose login credentials can be saved (e.g., on a web browser, on a local device, etc.) and easily accessed (e.g., by the click of a button). The recipient identifier can then be associated with an order with or without explicit communication with the buyer. Optionally, and address field can be auto filled with the intended delivery address as retrieved from the recipient profile.

The recipient identifier can be received from: a buyer (e.g., the recipient), a platform, a third-party entity involved in shipping, a third-party entity not involved in shipping (e.g., a credit card company involved in virtual check-out, a search engine, another account the buyer is logged into, etc.), and/or any other suitable entity. The recipient identifier can be digitally and/or physically (e.g., printed onto a label attached to a shipment) received. The recipient identifier can be received by: the platform, a third-party entity (e.g., vendor, fulfilment facility, carrier, delivery person, autonomous delivery vehicle, etc.), and/or any other suitable entity.

In a first example, the recipient identifier can be received by an intermediary shipping entity (fulfillment facility, sorting facility, routing facility, etc.). In a first illustrative example, the recipient identifier is physically printed on a shipment label (e.g., as an image, QR code, barcode, etc.) and optionally scanned by the carrier. In a second illustrative example, the recipient identifier is written (e.g., in text form) in or next to the address field and read by the carrier. In a third illustrative example, the recipient identifier is associated with a carrier's identifier for the shipment, wherein the recipient identifier is received through the carrier's mobile interface.

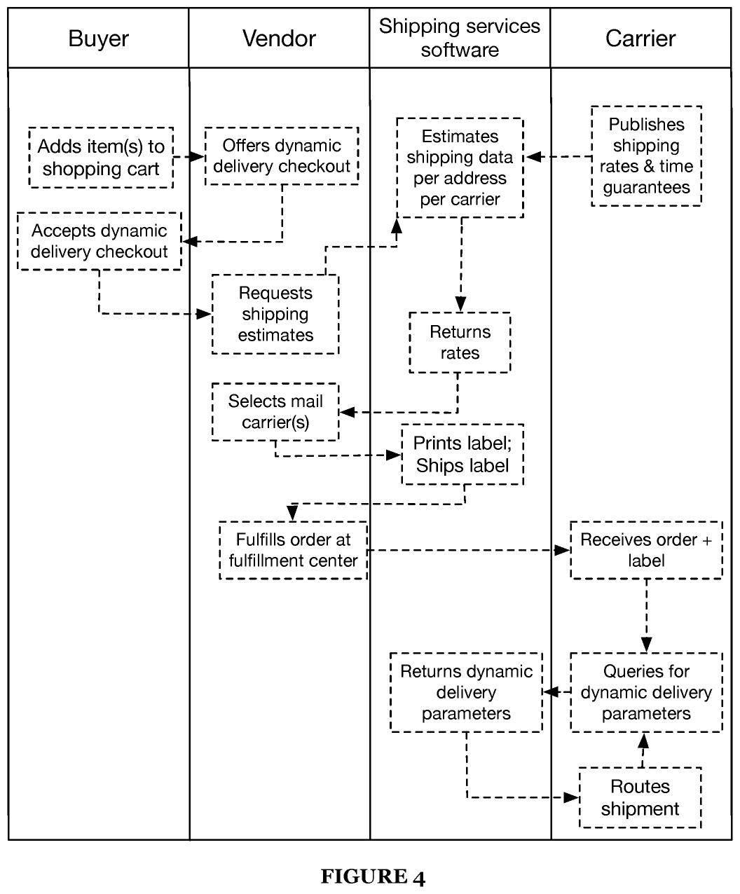

In a second example, a frontend interface (e.g., online retail site) receives a recipient identifier in an address field and identifies that it is a platform identifier. The frontend interface sends a request to the platform (e.g., EasyPost) including the recipient identifier. The platform then returns all possible delivery parameters (e.g., including delivery locations) associated with the recipient identifier to the frontend interface (e.g., example shown in FIG. 4). Subsequently, the frontend interface can: present the set of delivery locations to the buyer, wherein the buyer can select a delivery location for use as the target delivery location, determine (e.g., calculate, request, etc.) shipping fees based on the set of delivery locations (e.g., for each delivery location), and/or otherwise use the returned information.

In a third example, the request for a shipment can optionally include shipping parameters (e.g., estimated shipment weight, size, ship date, origin location, etc.), wherein the platform can optionally estimate the time in transit for each of the set of delivery locations associated with the recipient information, optionally filter the delivery locations based on the time in transit and/or the delivery condition(s) associated with the delivery locations (e.g., include only delivery locations associated with the estimated delivery day of week), and determine the carriers, services, and fees for each of the delivery locations (e.g., remaining delivery locations). The method can include returning the set of fees and/or estimated time in transit for each combination.

In variants, the receiving entity can validate the recipient identifier, recognize that the recipient identifier is an EasyPost identifier (e.g., and query the EasyPost API for information stored in the recipient profile), not validate the recipient identifier (e.g., wherein the recipient identifier is passed onto downstream entities), and/or otherwise process the recipient identifier.

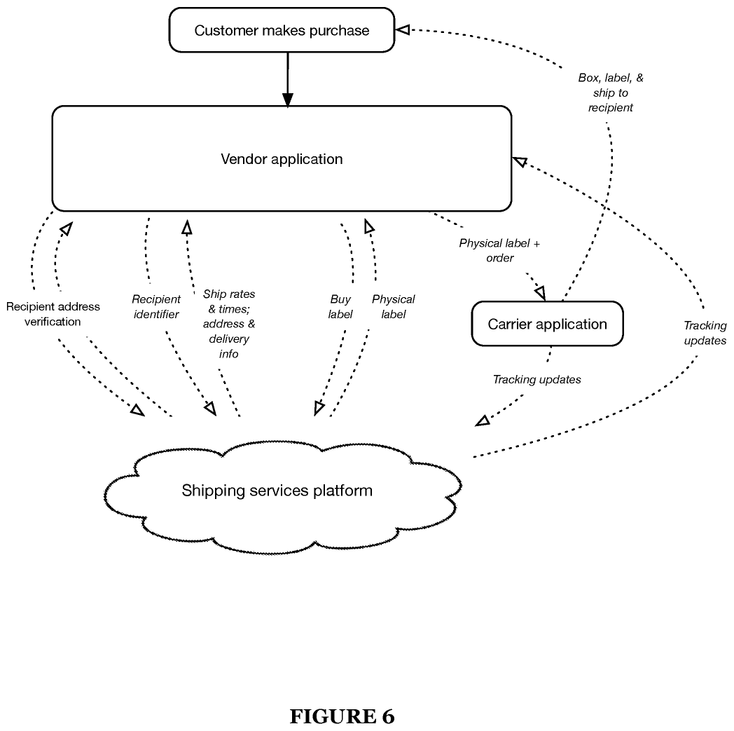

The receiving entity can optionally verify the recipient identifier (e.g., example shown in FIG. 6), the delivery parameters, and/or use of the dynamic delivery functionality with the recipient. Confirmation can be assumed (e.g., if a buyer proceeds with an order after delivery parameters are auto-filled) or explicit (e.g., wherein a confirmation button is pressed). Confirmation can occur at checkout, when an entity requests the delivery parameters (delivery parameters can be returned before or after buyer confirmation), at a predetermined moment during a shipment, and/or at any other suitable time. In examples, confirmation can occur by sending a notification to the buyer (e.g., via an EasyPost interface, an ecommerce interface, a carrier interface, a text message, an email, etc.) and receiving an affirmative response from the buyer.

However the recipient identifier can be otherwise received.

### 4.2 Determining Delivery Parameters S200

Determining delivery parameters S200 functions to use the recipient identifier to access the set of parameters that will dictate decision-making for mailing the shipment. S200 can be performed: when an entity requests the delivery parameters, periodically, at checkout (e.g., when auto-filling the delivery address), during a fulfilment period, at a hand-off (e.g., from vendor to shipping carrier, between carriers, etc.), prior to planning a delivery carrier's route, after a carrier has left a carrier facility with the shipment (e.g., a set number of stops before delivering the shipment), when a request including the recipient identifier is received, and/or at any other time. A delivery parameter request can be responsive to: a buyer entering their recipient identifier, a system recognizing a recipient identifier, a buyer placing an order, a vendor requesting information associated with a potential buyer, a shipping entity scanning a recipient identifier, requesting delivery parameter confirmation from a buyer, and/or any other event. S200 is preferably performed by a shipping services platform (e.g., EasyPost), but can additionally or alternatively be performed by any other entity (e.g., shipping providers, vendors, etc.). Generally, S200 includes requesting information using the recipient identifier and receiving information associated with the recipient profile.

In a first set of variants, S200 can include sending a request (e.g., using the recipient identifier) for delivery parameters and receiving a response to the request. In examples, S200 can include requesting a delivery parameter from a platform using a request including the unique recipient identifier and a set of shipping parameters.

In a first variant, all delivery parameters associated with the recipient identifier are returned. The requesting entity can optionally pick which delivery address to use.

In a second variant, only delivery parameters (e.g., addresses) associated with the recipient identifier that satisfy conditions (e.g., based on shipping parameters associated with a request) are returned. The shipping parameters can be received as part of the request, be determined from recipient preferences, predicted, or be otherwise determined. In a first example, the shipping parameters sent with the information request can include a requirement (e.g., a target delivery date, a two-day shipping requirement), wherein the system (e.g., the processing module 150) determines and returns the address associated with the requirement (e.g., the weekend delivery address for a Saturday target delivery date). In a second example, the shipping parameters can include a predicted delivery time (e.g., 6 pm), wherein the system determines and returns the address associated with the predicted delivery time (e.g., the home address). In a third example, the shipping parameters can include a shipping fee requirement (e.g., a threshold value), wherein the system determines and returns all addresses that have an estimated shipping fee lower than the threshold value (e.g., fee to ship from the origin address to the respective delivery address). In a fourth example, the shipping parameters can include shipment specifications (e.g., size, weight, origin, value, etc.), wherein determining delivery parameters can include selecting a carrier based on the shipment specifications, and selecting a delivery address based on the selected carrier. In a fifth example, the shipping parameters can indicate the shipment delivery stage (e.g., which leg the shipment is in), wherein the returned delivery parameters can include a geographic resolution pertinent to the respective delivery stage. In an illustrative example, the state can be provided to a fulfillment facility, while a zip code can be provided to a downstream carrier routing facility.

In a third variant, delivery parameters are determined and returned based on an entity identifier (e.g., for the requesting entity) received with a request. The entity identifier can be an entity class identifier, a business identifier, an entity-specific access token, a message, and/or any other form of identification. In a first example, the requesting entity is identified as a vendor, wherein potential shipping addresses, mail carriers, and/or other information are returned. In a second example, the requesting entity is identified as a carrier, wherein potential shipping addresses are returned. In a third example, the requesting entity is identified as a mail deliverer, wherein the delivery parameters returned can include the delivery address, delivery instructions (e.g., gate code, “do not leave unattended”, etc.) associated with the address, and/or other suitable information.

In a second set of variants, S200 can include responding to queries received with the recipient identifier (e.g., example shown in FIG. 3). In an example, S200 can include receiving a request (e.g., using the recipient identifier) for delivery parameters, and processing the request to determine a set of parameters to return. This set of variants can optionally be performed by a processing system (e.g., the processing module 150), which can optionally be hosted by the shipping services platform (e.g., EasyPost). Determining the set of parameters to return can be based on a set of rules, heuristics, models, and/or other decision-making processes.

In a first variant, upon receipt of a request, the processing system returns all delivery parameters associated with the recipient identifier.

In a second variant, upon receipt of a request, the processing system determines which delivery parameters to return based on the requesting entity. In an example, a set of rules maps the class of the requesting entity to the type of parameters returned (e.g., a vendor request yields the return of one or more delivery addresses and shipping costs per request, a carrier request yield the return of one or more delivery addresses and delivery time windows per address, a deliverer request yields the return of a delivery address and associated delivery instructions, etc.).

In a third variant, upon receipt of a request, the processing system determines which delivery parameters to return based on a set of shipping parameters. The shipping parameters can be: received with the request (e.g., from the requesting entity), received from another entity, internally accessed (e.g., wherein shipping parameters are tracked by the system), and/or otherwise determined. In a first example, rules can further dictate whether to select one set of delivery parameters (e.g., associated with one address) that satisfies the shipping parameters, or multiple sets of delivery parameters (e.g., associated with multiple addresses) that satisfy the shipping parameters. In a second example, the processing system can select the delivery parameter(s) where the shipping parameters satisfy the conditions associated with the respective delivery parameter. In an illustrative example, when the shipping parameters specify that the package will be delivered on a weekday during working hours, the processing system selects the delivery parameters associated with the weekday working hours. In a third example, determining the delivery parameter can include looking up the delivery parameter based on the set of shipping parameters (e.g., wherein the set of shipping parameters satisfy the set of conditions associated with the delivery parameter), and optionally include determining which of the set of shipping parameters satisfies the set of conditions associated with the set of available delivery parameters.

In a fourth variant, upon receipt of a request, the processing system determines which delivery parameters to return by inferring information about the shipping context. The shipping context can then be compared against the delivery conditions to determine which set of delivery parameters to return. The shipping context can be inferred based on: the time of receipt of the request, the location of receipt of the request, the predicted delivery timeline (e.g., in combination with tracking updates previously received), and/or any other information. In a first example, if a request is received an hour before the predicted delivery time (e.g., presumably by the mail deliverer), the delivery address and any delivery instructions associated with the address are returned. In a second example, if a request is received within several hours of an order being placed (e.g., presumably from a fulfilment center), only order information (e.g., shipment(s) and quantity) is returned.

In a fifth variant, any combination of the variants can be used to determine the delivery parameters to return in receipt of an information request.

However, determining delivery parameters can be otherwise performed.

### 4.3 Using the Delivery Parameters S300

Using the delivery parameters S300 functions to determine a response to the delivery parameters. Preferably, the delivery set of delivery parameters determined in S200 is used to perform S300. S300 can be performed after delivery parameters have been returned S200, but can additionally or alternatively occur between repetitions of S200. In variants, outputs of S300 can be used as shipping parameters for S200. All or portions of S300 can be performed one or more times by one or more entities (e.g., by a shipping services platform, a vendor, a mail carrier, etc.). In variants, S300 can be performed by: the vendor to select a carrier, the shipping services platform to provide carrier options to a vendor, the carrier to determine if they can guarantee a delivery request, the carrier to determine a shipment route, and/or any other entity for any other purpose.

Using the delivery parameters S300 can include: estimating shipping data, routing the shipment, displaying shipping data, pushing delivery parameters to an entity (e.g., a mail deliverer), and/or any other suitable elements.

Estimating shipping data can function to determine shipping data to enable route planning. The shipping data can be determined based on the delivery parameters determined in S200, based on shipping parameters, and/or based on any other suitable information. Shipping data can be determined for: one or more of the addresses, timeframes, carriers, preferred services (e.g., rush delivery, high value delivery, etc.) and/or other parameters returned by S200 and/or any combination of parameters.

In a first variant, estimating shipping data is performed by the vendor. In an example, the vendor receives a set of addresses, rules (e.g., timeframes) associated with each address, and optionally additional delivery parameters. The vendor can determine the cost and/or time to deliver to each address (e.g., for the vendor to deliver, for a third-party carrier to deliver, etc.). Estimating shipping data can include querying an internal and/or third-party system to predict a ship date (e.g., based on available inventory, fulfilment center capacity, etc.).

In a second variant, estimating shipping data is performed by a shipping services platform such as the platforms disclosed in U.S. patent application Ser. No. 17/729,295, filed 26 Apr. 2022, and U.S. patent application Ser. No. 17/966,093, filed 14 Oct. 2022, each of which is incorporated herein in its entirety by this reference. In an example, the platform receives a ship date (e.g., from the vendor) and predicts the delivery time for each delivery address and/or the rate for each delivery address for each of a set of carriers and/or services.

Routing the shipment can function to determine a route for a shipment. The route can be all or a subset of the route from an origin to the destination. The origin can be: the location of the requesting entity (e.g., fulfilment center, carrier center, delivery entity, etc.), the location of the next step in the shipping route (e.g., the upcoming fulfilment center, carrier center, etc.), and/or any other suitable location. The destination that is used can be: the delivery address returned by the system (e.g., from S200), a portion thereof (e.g., the zip code, the state, the city, etc.), and/or any other suitable destination. S300 can optionally include: purchasing a label, printing a label (e.g., wherein the recipient identifier is printed in an address field on the label), boxing the shipment, labeling the shipment, delivering the shipment to the intended recipient (e.g., a recipient associated with the unique recipient identifier), and/or any other shipping steps.

In a first variant, routing the shipment is based on the delivery parameters of S200.

In a second variant, routing the shipment is based on the selected delivery address (e.g., as determined in S200).

In a third variant, routing the shipment is based on the selected carrier, and optionally the selected service. In an example, the carrier and service are selected by the vendor for their prices, and the shipment is routed to an address based on the selection of carrier and service.

In a fourth variant, routing the shipment includes handing the shipment off by a first entity to an additional entity. Determining a hand-off can be determined by the first entity: in response to a request, upon determining that the entity cannot deliver according to the determined delivery parameters, upon determining that delivering according to the determined delivery parameters would exceed a constraint imposed upon the entity, and/or otherwise determined. The additional entity can be another mail carrier, a last-mile deliverer, and/or any other entity. In a first example, an entity may receive a shipment, determine that the target delivery time cannot be achieved by the entity, and hand off the shipment to another entity that can achieve the target delivery time. In a second example, handing off the shipment to a last-mile deliverer can be performed by a mail carrier as an alternative to initiating a return to sender (e.g., in response to the most recently determined delivery location being different from a previously-determined delivery location for the same recipient). In a third example, a mail carrier may carry a shipment in a delivery vehicle that experiences delays, determine that a first delivery address (e.g., the working address) can no longer be delivered to within the delivery time window specified in the delivery conditions, and hand-off the shipment to another entity to allow the shipment to be delivered to an alternate address (e.g., the home address) on the same day, rather than attempt an initial delivery or subsequent redelivery to the first delivery address outside of the specified time window.

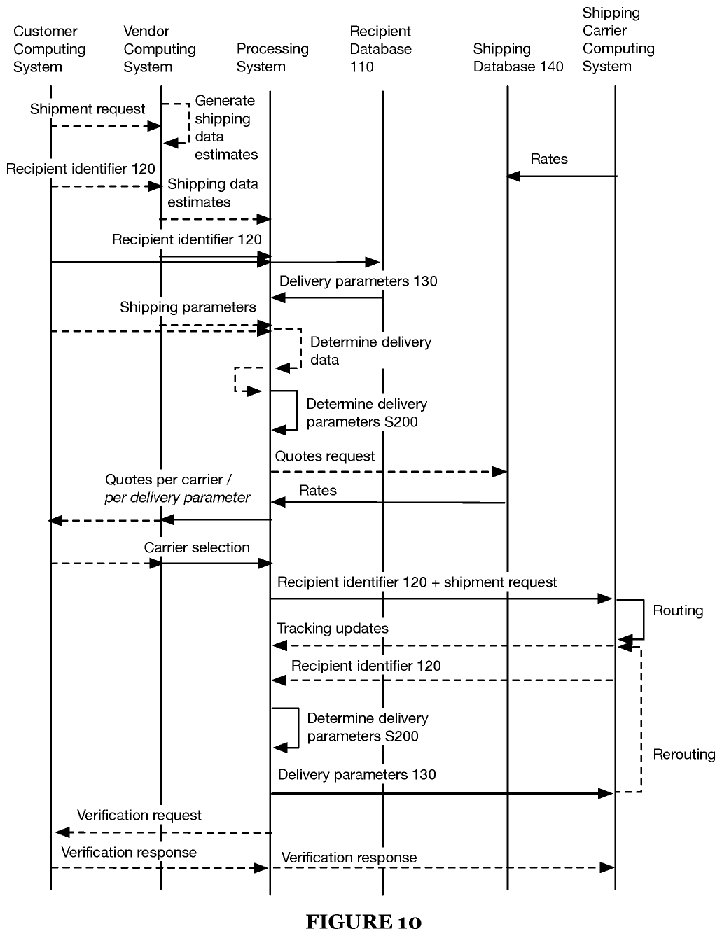

In a fifth variant, routing the shipment can include rerouting the shipment (e.g., example shown in FIG. 10). Rerouting can be performed in response to a verification response (e.g., wherein the recipient responds that they cannot receive the shipment at the designated time and/or address), in response to a delay (e.g., wherein the carrier is unable to deliver at/by the estimated time), in response to a request, and/or otherwise performed. Rerouting can include: rescheduling delivery at a later time (e.g., on the same day or at a later date), rescheduling delivery to a different address stored in the recipient profile (e.g., wherein any of steps S100-S300 are repeated), cancelling a delivery, handing off the delivery to another entity, requiring payment to initiate rerouting, and/or any other step.

In a sixth variant, routing the shipment includes determining a pickup and/or drop-off site (e.g., a parcel locker) to deliver the shipment to. Determining a drop-off site can be performed: in response to determining that a shipment cannot be delivered to a delivery address of the recipient and satisfy the delivery conditions (e.g., after the shipment is delayed en route, while initially routing the shipment, etc.), in response to receiving a request from a recipient or alternate entity, and/or responsive to any other event.

Displaying shipping data can function to communicate shipping data, route decisions, and/or other information to an entity (e.g., the recipient, a vendor, a carrier, etc.). In an example, the checkout window of a website can display: the carrier selected, the shipping price, the estimated shipping time, the estimated shipment arrival time, the packaged weight and/or dimensions of the shipment, and/or any other information associated with the shipment either before or after receiving confirmation from the user to purchase the shipment.

Pushing delivery parameters to an entity can function to communicate parameters pertinent to an upcoming delivery to an entity without receiving an explicit request from said entity. Pushing parameters can include sending an alert (e.g., an SMS, an email, a notification on a mobile interface, etc.) to an endpoint (e.g., the recipient, the mail deliverer, etc.), and/or otherwise sending information to an entity. The parameters can be sent: responsive to receipt of a request for the delivery parameters, at a predetermined time (e.g., time of day), at a predetermined distance from the delivery location, and/or when any other suitable event occurs.

However the delivery parameters can be otherwise used.

### 4.4 Updating the Recipient Profile S400

The method can optionally include updating the recipient profile S400, which functions to modify the set of delivery parameters 130 associated with the recipient profile.

In a first variant, the recipient profile is directly updated by the recipient. In examples, the recipient profile is updated through a portal, web browser application, mobile application, and/or any other mobile interface. The recipient can update the recipient profile at any time. In an example, if the recipient updates the recipient profile while one or more shipments are in progress, they can optionally be offered a selection of in-progress shipments for the update to affect.

In a second variant, the recipient profile is indirectly updated based on communications with the recipient. In an example, a query (e.g., about a specific order, about information stored in the recipient profile, etc.) is sent to the recipient (e.g., via a text) before, during, or after a delivery is made, a response is received from the recipient, and the recipient profile is updated based on the response.

In a third variant, updates to the recipient profile are determined (e.g., inferred) based on an analysis of historical shipment data associated with the recipient. The updates can be stored in the recipient database 110 in the recipient profile with or without communicating the update to the recipient. In an example, a recipient with multiple reported shipment theft claims is flagged (e.g., as a suspicious recipient) and an additional delivery parameter (e.g., an instruction to “hand deliver only”) can be added to the set of delivery parameters 130. In a second example, if multiple unsuccessful delivery attempts are made at a particular address for a time range (e.g., weekday afternoons, Mondays, etc.), the time preferences associated with that address can be automatically updated to prevent future unsuccessful attempts. Learning recipient behaviors, recipient preferences and/or detecting anomalous events can employ machine learning models and/or rule sets to flag events and determine patterns.

However the recipient profile can be otherwise updated.

### 4.4 Examples

In variants, the system can include: an optional interface; an optional database configured to store shipping data (e.g., package scan data, weather data, delivery parameters, etc.); a processing system; and/or any other system components. In an example, the interface can be configured to receive a request for a package, receive a recipient identifier, receive delivery parameters (e.g., delivery preferences), and/or receive and/or output any other information. In a specific example, the database can be updated (e.g., in real-time) during package transit with updated shipping data.

In variants, the processing system can be configured to: determine a first set of shipping data (e.g., delivery parameters, other delivery preferences, etc.); determine an initial shipping route based on the first set of shipping data; determine a second set of shipping data (e.g., updated shipping data); determine an updated shipping route based on the second set of shipping data; and optionally reroute (e.g., automatically reroute) the package according to the updated shipping route. In an example, the second set of shipping data (e.g., updated shipping data) can include at least one of: updated weather data, updated scan data for the package, or updated delivery parameters (e.g., updated delivery preferences). In an example, the initial shipping route can include a partial shipping route (e.g., without a final destination), and the updated shipping route can include a complete shipping route (e.g., including a final destination). A delivery vehicle (e.g., an autonomous delivery vehicle) can optionally be controlled (e.g., automatically controlled to transport the package according to the updated shipping route. In a specific example, the system can include the delivery vehicle.

In an example, the initial shipping route and/or updated shipping route can be determined using one or more models. In a specific example, each model can be associated with a set of shipping data (e.g., shipping carrier, delivery parameters such as a delivery address, current package location, weather data, current date, other shipping data, a combination thereof, etc.), and can be used to predict an estimated delivery time for the package for the associated set of shipping data. In a specific example, the set of shipping data can prescribe a shipping route, wherein each model is associated with a (candidate) shipping route. For example, inputs to the model can include: shipping data (e.g., target delivery location, initial ship location, current location, current date, weather data, package size, package type, shipping carrier, etc.) and/or any other suitable inputs. For example, outputs from the model can include: an estimated delivery time (e.g., date and time), a confidence parameter for the estimated delivery time, and/or any other suitable outputs. Each model is preferably trained using historical shipping data corresponding to the associated shipping data (e.g., same shipping carrier, same delivery zip code, etc.), but can alternatively be trained using any other training data. In a specific example, a shipping route can be determined for the package by: for each of a set of candidate shipping routes, predicting an estimated delivery time for the package using a model corresponding to the candidate shipping route (e.g., trained using historical shipping data associated with the candidate shipping route), and selecting a shipping route from the set of candidate shipping routes based on the estimated delivery times and a set of delivery parameters (e.g., delivery conditions for each delivery address). In a specific example, the shipping route can be further determined based on a confidence parameter for each estimated delivery times (e.g., output from the models). In an example, a shipping route can include at least one of: delivery address, delivery time, or shipping carrier. Models can optionally be retrained in response to receiving updated shipping data for the package (e.g., updated scan information, updated delivery parameter, etc.), wherein a new shipping route can be determined using the retrained models. In a specific example, models (e.g., the set of machine learning models) can be retrained in response to receiving the updated shipping data (e.g., in response to the database receiving the updated shipping data, in response to retrieving the updated shipping data form the database, etc.).

In a first embodiment, the processing system can be configured to: retrieve, from the database, shipping data for the package; based on the shipping data, determine an initial shipping route using a set of machine learning models; retrieve, from the database, updated shipping data for the package; select updated training data based on the updated shipping data; retrain the set of machine learning models using the updated training data; determine an updated shipping route using the retrained set of machine learning models; and automatically reroute the package according to the updated shipping route.

In an example, each machine learning model can be associated with a shipping carrier in a set of shipping carriers (e.g., last-mile shipping carriers). In a specific example, selecting the updated training data can include, for each machine learning model, selecting historical shipping data corresponding to the updated shipping data and the shipping carrier associated with the machine learning model. In a specific example, determining the updated shipping route can include, for each shipping carrier in the set of shipping carriers, predicting a delivery time using the retrained machine learning model associated with the shipping carrier, and selecting a shipping carrier based on the predicted delivery times and a set of delivery parameters associated with the package.

In an example, updated shipping data can include a set of updated delivery parameters associated with the package, wherein each updated delivery parameter is associated with a machine learning model in the set of machine learning models. In a specific example, selecting updated training data can include, for each updated delivery parameter, selecting historical shipping data corresponding to the updated delivery parameter.

In an example, determining the updated shipping route can include: predicting a delivery time for each updated delivery parameter in the set of updated delivery parameters; and determining the updated shipping route based on the predicted delivery times and a set of delivery conditions associated with the set of updated delivery parameters.

In a second embodiment, the processing system can be configured to: retrieve a set of delivery preferences associated with a recipient identifier; based on the set of delivery preferences, determine an initial shipping route using a set of machine learning models; receive updated shipping data associated with the package during package transit; based on the updated shipping data, determine an updated shipping route using the set of machine learning models; and automatically reroute the package according to the updated shipping route.

In an example, determining an updated shipping route using the set of machine learning models can include selecting updated training data based on the updated shipping data and retraining the set of machine learning models using the updated training data.

In an example, determining the updated shipping route can include: for each machine learning model in the set of machine learning models, predicting a delivery time based on the updated shipping data; and determining the updated shipping route based on the predicted delivery times and the set of delivery preferences. In a specific example, the updated shipping route can be further determined based on a confidence parameter for each predicted delivery time.

In an example, determining the initial shipping route can include determining a first subset of delivery parameters from the set of delivery parameters, wherein determining the updated shipping route can include determining a second subset of delivery parameters from the set of delivery parameters. In a specific example, rerouting the package according to the updated shipping route can include providing the second subset of delivery parameters to a shipping carrier. In a specific example, the first subset of delivery parameters includes a first address, and the second subset of delivery parameters includes a second address.

Different processes and/or elements discussed above can be performed and controlled by the same or different entities. In the latter variants, different subsystems can communicate via: APIs (e.g., using API requests and responses, API keys, etc.), requests, and/or other communication channels. Communications between systems can be encrypted and/or decrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUS, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A system, comprising:
an interface configured to receive a request for a package;
a database configured to store shipping data, wherein the database is updated in real-time during package transit; and
a processing system configured to:
retrieve, from the database, shipping data for the package;
based on the shipping data, determine an initial shipping route using a set of machine learning models;
retrieve, from the database, updated shipping data for the package during package transit;
select updated training data based on the updated shipping data;
retrain the set of machine learning models using the updated training data;
determine an updated shipping route using the retrained set of machine learning models; and
automatically reroute the package according to the updated shipping route.

2. The system of claim 1, wherein the updated shipping data comprises at least one of: updated scan data for the package, updated weather data, or updated delivery parameters.

3. The system of claim 1, wherein each machine learning model is associated with a shipping carrier in a set of shipping carriers, wherein selecting the updated training data comprises, for each machine learning model, selecting historical shipping data corresponding to the updated shipping data and the shipping carrier associated with the machine learning model, wherein determining the updated shipping route comprises, for each shipping carrier in the set of shipping carriers, predicting a delivery time using the retrained machine learning model associated with the shipping carrier, and selecting a shipping carrier based on the predicted delivery times and a set of delivery parameters associated with the package.

4. The system of claim 3, wherein the set of shipping carriers comprises a set of last-mile shipping carriers.

5. The system of claim 1, wherein the updated shipping data comprises a set of updated delivery parameters associated with the package, wherein each updated delivery parameter is associated with a machine learning model in the set of machine learning models, wherein selecting updated training data comprises, for each updated delivery parameter, selecting historical shipping data corresponding to the updated delivery parameter.

6. The system of claim 5, wherein the set of updated delivery parameters comprises a set of addresses.

7. The system of claim 5, wherein determining the updated shipping route comprises:
predicting a delivery time for each updated delivery parameter in the set of updated delivery parameters; and
determining the updated shipping route based on the predicted delivery times and a set of delivery conditions associated with the set of updated delivery parameters.

8. The system of claim 1, wherein the set of machine learning models are retrained in response to retrieving the updated shipping data.

9. The system of claim 1, wherein the updated shipping route comprises at least one of: delivery address, delivery time, or shipping carrier.

10. The system of claim 1, wherein the initial shipping route comprises a partial shipping route, wherein the updated shipping route comprises a complete shipping route.

11. A system, comprising:
an interface configured to receive a request for a package and a recipient identifier; and
a processing system configured to:
retrieve a set of delivery preferences associated with the recipient identifier;
based on the set of delivery preferences, determine an initial shipping route using a set of machine learning models;
receive updated shipping data associated with the package during package transit;
based on the updated shipping data, determine an updated shipping route using the set of machine learning models; and
automatically reroute the package according to the updated shipping route.

12. The system of claim 11, wherein a delivery vehicle is automatically controlled to transport the package according to the updated shipping route.

13. The system of claim 11, wherein the updated shipping data comprises at least one of: updated weather data, updated scan data for the package, or updated delivery preferences associated with the recipient identifier.

14. The system of claim 11, wherein the set of delivery preferences comprise a set of addresses and a set of delivery conditions for each address.

15. The system of claim 11, wherein determining the updated shipping route using the set of machine learning models comprises selecting updated training data based on the updated shipping data and retraining the set of machine learning models using the updated training data.

16. The system of claim 11, wherein determining the updated shipping route comprises:
for each machine learning model in the set of machine learning models, predicting a delivery time based on the updated shipping data; and
determining the updated shipping route based on the predicted delivery times and the set of delivery preferences.

17. The system of claim 16, wherein the updated shipping route is further determined based on a confidence parameter for each predicted delivery time.

18. The system of claim 1, wherein determining the initial shipping route comprises determining a first subset of delivery parameters from the set of delivery parameters, wherein determining the updated shipping route comprises determining a second subset of delivery parameters from the set of delivery parameters, wherein automatically rerouting the package according to the updated shipping route comprises providing the second subset of delivery parameters to a shipping carrier.

19. The system of claim 18, wherein the first subset of delivery parameters comprises a first address, wherein the second subset of delivery parameters comprises a second address.

20. The system of claim 1, wherein the updated shipping route comprises at least one of: delivery address, delivery time, or shipping carrier.
